(19) United States
(12) Patent Application Publication
(10) Pub. No.: US 2019/0040657 A1
(43) Pub. Date: Feb. 7, 2019

(54) Motor Vehicle Lock with Crash Lever

(71) Applicant: BROSE Schliebetasysteme GmbH & Co. KG, Wuppertal (DE)

(72) Inventors: Matthew Goldsworthy, Oakland TWP, MI (US); David Rosales, Rochester Hills, MI (US); Kwanggi Lee, Rochester Hills, MI (US)

(73) Assignee: BROSE Schliebetasysteme GmbH & Co. KG, Wuppertal (DE)

(21) Appl. No.: 15/669,211

(22) Filed: Aug. 4, 2017

(51) Int. Cl. E05B 77/04

(52) U.S. Cl. CPC E05B 77/04

(57) ABSTRACT

The present invention relates to a crash lock. In order to provide a facilitated crash lock, a motor vehicle lock arrangement for a motor vehicle door is provided. The motor vehicle lock module comprises a motor vehicle door lock and a crash element. The motor vehicle door lock comprises a locking mechanism inside a housing of the motor vehicle door lock to lock the motor vehicle door lock. The locking mechanism has at least one transmission element arranged on the outside of the housing. The transmission element is configured to transmit an actuating movement to the locking mechanism, and the transmission element is configured for connection with at least one of the group of an inner locking operation element and outer locking operation element. The crash element comprises a first abutment portion and a second abutment portion. The first abutment portion is configured to be urged by a deformed outer cover sheet of a motor vehicle door in case of a deformation of the outer cover sheet due to a crash, thus causing at least a partial movement of the crash element. The second abutment portion is configured to urge on the transmission element in case of the at least partial movement of the crash element, thus causing a movement of the transmission element for locking of the vehicle door lock by the locking mechanism.

### FIELD OF THE INVENTION

The present invention relates to a crash lock of a motor vehicle lock, and relates, in particular, to a motor vehicle lock arrangement for a motor vehicle door, to a lock module for a motor vehicle door, to a motor vehicle door module for a motor vehicle door arrangement and to a method for locking a motor vehicle door in a crash situation.

### BACKGROUND OF THE INVENTION

In motor vehicles, locks are used for locking doors and the like in their closed state. In crash situations, additional measures may be taken in order to prevent an unwanted opening of the door during the crash situation. For example, a crash is detected by sensors and a crash lock is activated that acts on the lock such that the lock cannot be opened and the door is securely hold in the closed position. As an example, US 2017 0074003 A1 describes a motor vehicle lock arrangement with a crash detection element in form of an elongate force transmission element for transmission of pulling forces. The elongate force transmission element extends through a part of the vehicle door and is coupled to a control mechanism which can be switched to a disabled state. In an enabling state, the control mechanism can be used for unlocking the lock. In the disabled state, an actuation lever, on which a door handle can act, is disabled. Hence, the actuation of the actuation lever does not lead to a deflection of a lock element inside the lock. In a crash, a deformation of the outer door sheets acts on the elongate force transmission element. However, it has been shown that the installation of the elongate force transmission element requires installation space that may be needed for other purposes.

### SUMMARY OF THE INVENTION

There may thus be a need to provide a facilitated crash lock.

The object of the present invention is solved by the subject-matter of the independent claims; further embodiments are incorporated in the dependent claims. It should be noted that the following described aspects of the invention apply also for the motor vehicle lock arrangement for a motor vehicle door, for the lock module for a motor vehicle door, for the motor vehicle door module for a motor vehicle door arrangement and for a method for locking a motor vehicle door in a crash situation.

According to the present invention, a motor vehicle lock arrangement for a motor vehicle door is provided. The motor vehicle lock arrangement comprises a motor vehicle door lock and a crash element. The motor vehicle door lock comprises a locking mechanism inside a housing of the motor vehicle door lock to lock the motor vehicle door lock. The locking mechanism has at least one transmission element arranged on the outside of the housing. The transmission element is configured to transmit an actuating movement to the locking mechanism, and the transmission element is configured for connection with at least one of the group of an inner locking operation element and outer locking operation element. The crash element comprises a first abutment portion and a second abutment portion. The first abutment portion is configured to be urged by a deformed outer cover sheet of a motor vehicle door in case of a deformation of the outer cover sheet due to a crash, thus causing at least a partial movement of the crash element. The second abutment portion is configured to urge on the transmission element in case of the at least partial movement of the crash element, thus causing a movement of the transmission element for locking of the vehicle door lock by the locking mechanism.

This provides a reliable crash lock that requires a minimum number of parts. In particular, the lock does not require any cumbersome modifications, as an existing locking mechanism can be used.

According to an aspect, the activation force for actively locking the locking mechanism of the motor vehicle door lock is provided by the crash force itself resulting in a deformation of the door cover which then leads to the movement of the crash element which then acts on the transmission element of the door lock, in order to lock the door, i.e. to block the door lock, in the same way as with activating the operation element for locking the door.

A standard door lock can be used that has a transition element on the outside of the housing for connection to an exterior (of the housing) drive element. The crash element acts on that existing transition element.

The crash element provides a motor vehicle lock arrangement enhanced with a crash lock function. If the door lock is actively locked by the locking mechanism, for example activated by a central lock mechanism or by manually activating, there will be no crash-activated locking in case a crash appears.

The crash lever transmits a deformation of the cover sheet, which deformation results from a crash, into an activation movement for activating the locking mechanism. In a crash, the deformation is commonly acting on the cover sheet with a vector component transverse to the cover sheet. A pivoting crash lever transforms the direction of the deformation into a differently oriented movement for activating a transmission element in a direction other than the vector component transverse to the cover sheet. A lever gearing mechanism is thus provided.

The crash lever can be provided as an externally arranged element without the need to change the lock design. The crash lever can be provided as an adapted lever depending on existing or prevailing spatial relations.

According to an example, a pivot support is provided and the crash element is a crash lever pivotably hold by the pivot support.

According to an example, the pivot support is provided by the housing of the motor vehicle door lock, by a support structure of the vehicle lock arrangement, or by a structural part of the door.

According to an example, a projection is provided on the crash element for abutment on a rigid support portion to act as secondary pivot support when the crash element is moved by the deformation of the outer cover sheet in relation to the rigid portion. The rigid support portion and the pivot support are provided on different structural parts.

According to the present invention, also a lock module for a motor vehicle door is provided. The lock module comprises a support structure and a motor vehicle lock arrangement according to one of the preceding and below examples. The motor vehicle lock arrangement is mounted to the support structure. Further, the support structure is configured to be mounted to a door frame structure of a motor vehicle door. The support structure provides support for at least one of the group of motor vehicle lock, inner door handle, outer door handle, drive elements for the motor vehicle lock, drive elements for an electrically driven window pane, window pane guidance and sensor elements.

According to an example, the support structure is provided as a multifunctional bracket (MFB) configured as mounting structure for pre-mounting of components of the vehicle door.

According to the present invention, also a motor vehicle door module for a motor vehicle door arrangement is provided. The motor vehicle door module comprises a mounting plate structure and a motor vehicle lock arrangement according to one of the preceding and below examples. The motor vehicle lock arrangement is mounted to the mounting plate structure. Further components of the motor vehicle door are mounted to the mounting plate structure. The mounting plate structure is configured to be mounted to a door frame structure of a motor vehicle door.

According to the present invention, also a method for locking a motor vehicle door in a crash situation is provided. The method comprises the following steps:

a) deforming an outer cover sheet of a motor vehicle door in a crash situation; and
b) transforming the deformation of the outer cover sheet as an actuating movement to a locking mechanism of a motor vehicle door lock by:

b1) moving a crash element from an initial state towards a locking state by urging of the deformed outer cover onto a first abutment portion of the crash element; and

b2) moving a transmission element, which is configured to transmit an actuating movement to the locking mechanism by urging of a second abutment portion of the crash element onto the transmission element.

The locking mechanism is arranged inside a housing of the motor vehicle door lock to lock the motor vehicle door lock. The transmission element is arranged on the outside of the housing, and the transmission element is configured to transmit an actuating movement to the locking mechanism, and the transmission element is configured for connection with at least one of the group of an inner locking operation element and outer locking operation element.

The steps a) and b) are provided more or less simultaneously.

These and other aspects of the present invention will become apparent from and be elucidated with reference to the embodiments described hereinafter.

### BRIEF DESCRIPTION OF THE DRAWINGS

Exemplary embodiments of the invention will be described in the following with reference to the following drawings:

FIG. 1 shows a schematic illustration of an example of a motor vehicle lock arrangement.

FIG. 2 shows a schematic illustration of an example of a lock module for a motor vehicle door.

FIG. 3 shows a schematic illustration of an example of a motor vehicle door module.

FIG. 4 shows a perspective illustration of an example of a lock module with a motor vehicle lock arrangement.

FIG. 5 shows a perspective illustration of a further example of a lock module with a motor vehicle lock arrangement.

FIG. 6 shows basic steps of an example of a method for locking a motor vehicle door in a crash situation.

### DETAILED DESCRIPTION OF EMBODIMENTS

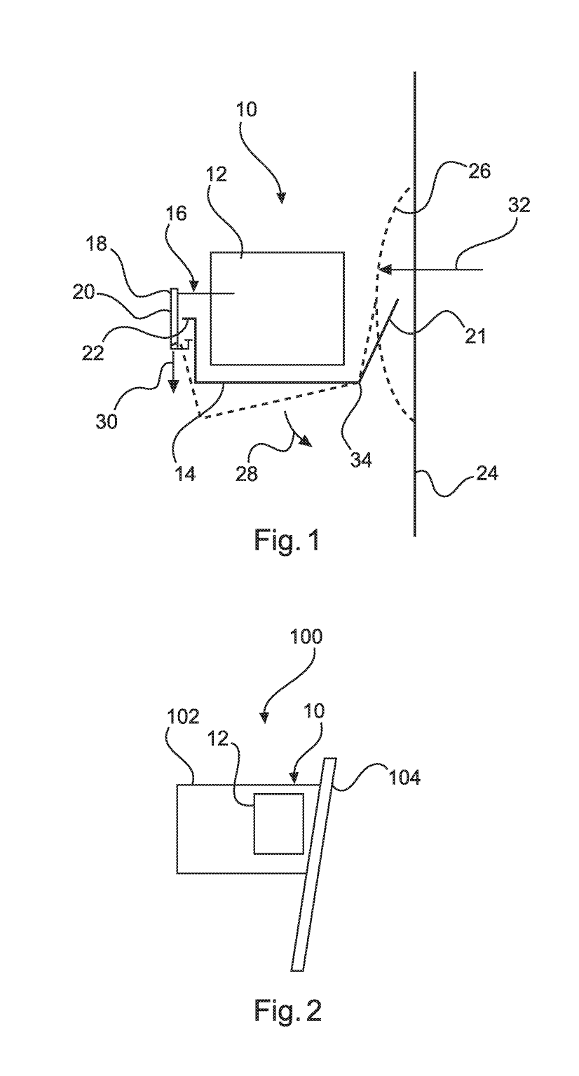

FIG. 1 shows a motor vehicle lock arrangement 10 for a motor vehicle door, the motor vehicle lock arrangement comprising a motor vehicle door lock 12 and a crash element 14. The motor vehicle door lock 12 comprises a locking mechanism 16 inside a housing 18 of the motor vehicle door lock 12 to lock the motor vehicle door lock 12. The locking mechanism 16 has at least one transmission element 20 arranged on the outside of the housing 18. The transmission element 20 is configured to transmit an actuating movement to the locking mechanism 16, and the transmission element 20 is also configured for connection with at least one of the group of an inner locking operation element and outer locking operation element. An inner locking operation element may be, for example, a knob to lock the door. An outer locking operation element may be, for example, a lock part with a key insert to lock the door by key movement. The crash element 14 comprises a first abutment portion 21 and a second abutment portion 22. The first abutment portion 21 is configured to be urged by a deformed outer cover sheet 24 of a motor vehicle door in case of a crash-caused deformation 26, indicated with a hashed line, of the outer cover sheet 24 due to a crash, thus causing at least a partial movement, indicated with a first arrow 28, of the crash element 14. The second abutment portion 22 is configured to urge on the transmission element 20 in case of the at least partial movement of the crash element 14, thus causing a movement, indicated with a second arrow 30, of the transmission element 20 for locking of the vehicle door lock 12 by the locking mechanism 16. An arrow 32 indicates an impact from the right with respect of the drawing. This impact is an example of a crash situation.

The motor vehicle “lock arrangement” can also be referred to as motor vehicle “lock module”.

The term motor vehicle “door” relates to moveable closures of openings of a vehicle, like pivoting doors, wing doors, sliding doors and trunk lids (also known as boot lids).

The term “motor vehicle door” relates to a motor vehicle door assembly or motor vehicle door arrangement. This can be an arrangement, which is readily mounted and equipped for being mounted to a vehicle arrangement during manufacturing and assembly. This can also be an arrangement, which is a prepared state of the door construction for being supplemented by further components or elements, like adding the final outside or inside cladding.

The “motor vehicle door lock” relates to a mechanism provided to temporarily hold the door in a closed position, and to allow a controlled opening by releasing the door. The door can thus be closed and can be at least temporarily secured (or locked) in the closed state by the door lock.

The “housing” of the lock refers to a structure enclosing the mechanism comprising interacting parts like a lock latch and a detent pawl assigned to the lock latch. The housing may enclose the moving and interacting parts in a protective and encapsulating manner. However, for engaging and holding a lock striker, e.g. the lock striker fixedly mounted to a frame portion of the vehicle, an opening in the housing may be provided, for example an entry opening for receiving the lock striker.

The “housing” of the motor vehicle door lock housing can also be referred to as “lock housing”.

The term “outside” the housing relates to an arrangement at least partly on the outer side of the housing.

The “locking mechanism” is provided to temporarily block (or lock, or latch) the motor vehicle lock. When blocked, the lock engages with a lock striker and cannot be moved, as it is locked, such that a release of the lock striker is prevented. Thus, an opening of the door is not possible, as the lock striker would have to be released for an opening. The locking mechanism is activated for example, when the vehicle is parked and not in use. The locking mechanism can also be activated for locking the door during use to prevent an unwanted opening of the door. For activation, control elements like knobs, latches or levers can be provided, or activation via actuators by generating an electric signal to active the locking mechanism via a drive element.

The term “locking the motor vehicle door lock” relates to change the state of the motor vehicle door lock such that an opening of the door lock, i.e. a release of a lock striker, and thus an opening of the motor vehicle door is prevented. The locking can be provided by a blocking of the door lock mechanism such that a movement of the pawl (for example resulting from a manual movement of a handle or from an activated drive element) to release the lock striker is blocked. The locking can also be provided by an interruption of the functional chain inside the lock such that a movement to move the pawl in order to release the lock striker is not transferred to the pawl.

The “transmission element” relates to a movably hold part, which is connectable to an activation element, like a lever, knob, switch or drive, like a mechanical, electromagnetic, pneumatic or hydraulic drive. The transmission element provides the transmission of the activating movement from outside the housing into the inside of the housing, where it may result in a blocking of the functional chain or where it may result in an interruption of the functional chain.

The transmission element can also be referred to as actuating element.

In an example, the second abutment portion is configured to urge on the transmission element in case of the at least partial movement of the crash element causing a change of the vehicle door lock from an unlocked state to a locked state.

An inner locking operation element may be a knob or lever arranged inside the vehicle space to be reachable by a passenger for locking the door lock, or a switch arranged inside the vehicle space to activate a drive element for locking the door lock.

An outer locking operation element may be a connection to a drive element activated by a car key when turning around, or by a sensor in case of contactless key operation.

In an example, the crash lever extends around a window pane guiding channel. The crash lever thus reaches from the outer side of the door's interior to an inner side of the door's interior. The term “inner” relates to an orientation towards the passenger compartment or cabin. The term “outer” relates to an orientation towards the outside of the vehicle, i.e. away from the vehicle.

In FIG. 1, as option it is shown to provide a pivot support 34, and the crash element is a crash lever pivotably hold by the pivot support. In an option, the pivot support 34 is provided by one of the group of: the housing of the motor vehicle door lock; a support structure of the vehicle lock arrangement; and a structural part of the door.

In an example, the first abutment portion 21 is arranged on one side of the pivot support 34, and the second abutment portion 22 is arranged on the other side of the pivot support 34.

FIG. 2 shows a lock module 100 for a motor vehicle door. The lock module 100 comprises an example of the motor vehicle lock arrangement 10 as described above and below. Further, a support structure 102 is provided. The motor vehicle lock arrangement 10 is mounted to the support structure 102. The support structure 102 is configured to be mounted to a door frame structure (not further shown) of a motor vehicle door. The support structure 102 provides support for at least one of the group of motor vehicle lock, inner door handle, outer door handle, drive elements for the motor vehicle lock, drive elements for an electrically driven window pane, sensor elements, and window pane guidance. The lock module can also be referred to as mini-module.

FIG. 3 shows a motor vehicle door module 200 for a motor vehicle door arrangement, comprising an example of the motor vehicle lock arrangement 10 as described above and below. Further, a mounting plate structure 202 is provided. The motor vehicle lock arrangement 10 is mounted to the mounting plate structure 202. Further components 204 of the motor vehicle door are mounted to the mounting plate structure 202. The mounting plate structure 204 is configured to be mounted to a door frame structure (not shown in detail).

For example, the vehicle lock arrangement is directly or indirectly mounted to the mounting plate structure.

The further components 204 may comprise at least one of the group of: inner and outer door handle, electric drive for window pane movement, electromagnetic actuators for opening and closing a door lock, electromagnetic actuators for activating a locking mechanism of the door lock, loudspeaker, light elements for illuminating the vehicle interior space or for decoration purposes, window pane guides, and a sealing pane arrangement to divide the door's inside space into a wet area and a dry area.

As examples for further components 204, an inner door handle 204a, two lateral window pane guides 204b, and a loudspeaker 204c are shown.

In an example, the mounting plate structure 202 is configured as a separator between a dry side and a wet side of the motor vehicle door interior space.

In an example, the motor vehicle door module also comprises an outer cover sheet, which, when being deformed in a crash situation, acts on the first abutment portion of the crash element.

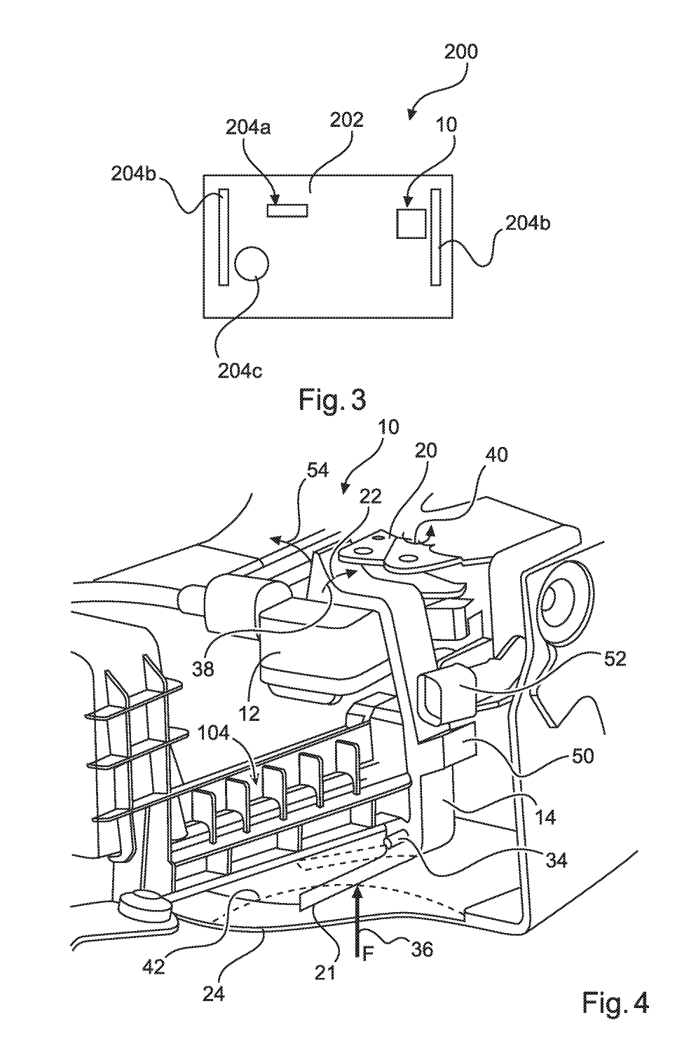

FIG. 4 shows a perspective view of an example of the motor vehicle lock arrangement 10. The crash element 14 is supported by the pivoting support 34. Thus, an activation force F, indicated with arrow 36, acting on the crash element 14, leads to a pivoting motion and thus to a movement of the other end of the crash element as indicated with further arrow 38. Thus, the transmission element 20 is rotated around its rotation point, as indicated with rotation arrow 40. The activation force F results from a deformation of the outer sheet 24 of the door. A hashed line 42 indicates the deformed state.

In an example, the transmission element 20 is provided as a transmission lever, and the second abutment portion is configured to act on the transmission lever in a crash situation to cause an activation of the transmission lever for locking the motor vehicle door lock, for example by a pivoting movement of the transmission latch.

In another example (not shown), the transmission element is provided as a transmission latch, and the second abutment portion is configured to act on the transmission latch in a crash situation to cause an activation of the transmission latch for locking the motor vehicle door lock, for example by a sliding movement of the transmission latch.

In an example, the crash element is hold with a holding force 54 to prevent unintended movement. The holding force is lower than an urging force resulting from the deformation of the outer cover in a crash situation.

In an option, for manually unlocking the locking mechanism after a crash, the crash element can be displaced with an opening force acting on the transmission element such that the transmission element is no longer blocked in a locked state.

The opening force may be provided by, for example, firemen or other rescue staff in the attempt to open the vehicle door, e.g. by applying mechanical tools to a door handle.

In an example, the crash element comprises at least one deformable portion such that the opening force results in a deformation thus enabling the transmission element to move for being able to unlock (or open) the locking mechanism.

In an example, the deformable portion is elastically deformable for enabling a multiple use of the crash element.

In an example, the crash element comprises a predetermined breaking point. In another example, an abutting portion is provided that comprises an inclined portion acting as a ramp that laterally shifts the crash element out of engagement with the transmission element when the opening force is activated.

In an example, the crash element is biased in its initial state. In another example, the crash element is hold by a pivoting support with a predetermined friction force.

In an example, the crash element is hold in an initial position such that the second abutment portion is arranged outside a movement range of the transmission element of the locking mechanism during normal operation of the locking mechanism. In other words, when there is no crash, the crash element does not interact with the transmission element.

In FIG. 4, an example of the multifunctional bracket 104 is provided as an option.

In an example, as shown in FIG. 4, the support structure 102 is provided with the pivot support 34 to pivotably hold the crash element. In an option, the support structure 102 is provided as a multifunctional bracket 104 configured as mounting structure for pre-mounting of components of the vehicle door.

As an option, it is shown in FIG. 4 to provide a projection 50 on the crash element 14 for abutment on a rigid support portion 52 to act as secondary pivot support when the crash element is moved by the deformation of the outer cover sheet in relation to the rigid portion. The rigid support portion 52 and the pivot support 34 are provided on different structural parts. In the example, the pivot support 34 is arranged on a support structure like the multifunctional bracket 104 forming a mounting support for the door lock. The rigid support portion, i.e. the secondary pivot support, is arranged on a component rigidly connected to the door frame structure (not shown in detail).

In an example, the multifunctional bracket comprises the pivot support for the crash element 14. As an option, an enforced part of an adjacent part of the lock arrangement acts as the rigid support portion to provide a secondary pivoting point, for example in case the multifunctional bracket is also moved in a crash situation.

In an example, the pivot support is provided as a clip-on portion clipped onto a rib structure of the multifunctional bracket. This allows to use existing multifunctional bracket designs and to enhance them with the crash locking function.

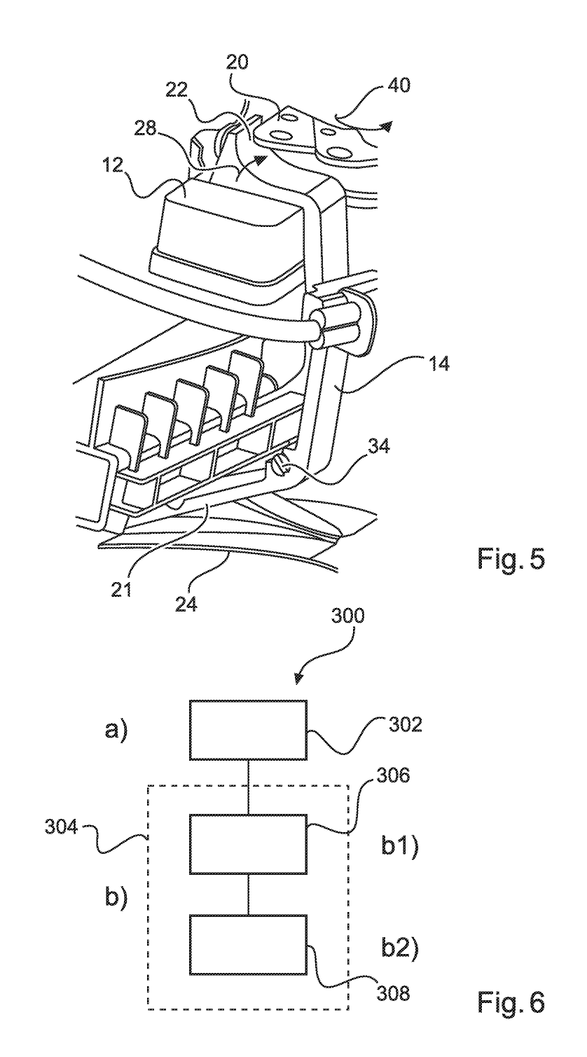

FIG. 5 shows a further example in a perspective view. The crash element 14 is shown without the projection 50 as an option.

In an example, a combination with a pivot support is provided as an option.

In an example, a combination with a projection on the crash element for abutment on a rigid support portion is provided as an option.

In an example, a combination with the transmission lever is provided as an option.

In an example, a combination with the hold with a holding force is provided as an option.

In an example, a combination with the crash element being displaceable with an opening force is provided as an option.

In another example, a combination with the support structure provided as a multifunctional bracket configured as mounting structure for pre-mounting of components of the vehicle door is provided as an option.

These combinations are also provided for the motor vehicle lock arrangement and for the lock module as well as for the motor vehicle door module

In an option, the embodiment of claim 10 is also combined with the embodiment of claim 9. In an option, the embodiment of claim 4 is also combined with the embodiment of claim 2 or 3. In an option, the embodiment of claim 5 is also combined with the embodiment of at least one of claim 1, 2, 3 or 4. In an option, the embodiment of claim 6 is also combined with the embodiment of at least one of claim 1, 2, 3, 4 or 5. In another option, the embodiment of claim 7 is also combined with the embodiment of at least one of claim 1, 2, 3, 4, 5 or 6.

FIG. 6 shows an example of a method 300 for locking a motor vehicle door in a crash situation. The method comprises the following steps: In a first step 302, also referred to as step a), an outer cover sheet of a motor vehicle door is deformed in a crash situation. In a second step 304, also referred to as step b), the deformation of the outer cover sheet is transformed as an actuating movement to a locking mechanism of a motor vehicle door lock. This is achieved by a first sub-step 306, also referred to as sub-step b1), in which a crash element is moved from an initial state towards a locking state by urging of the deformed outer cover onto a first abutment portion of the crash element. Further, in a second sub-step 308, also referred to as sub-step b2), a transmission element, which is configured to transmit an actuating movement to the locking mechanism, is moved by urging of a second abutment portion of the crash element onto the transmission element. Further, the locking mechanism is arranged inside a housing of the motor vehicle door lock to lock the motor vehicle door lock. Still further, the transmission element is arranged on the outside of the housing, and the transmission element is configured to transmit an actuating movement to the locking mechanism, and the transmission element is configured for connection with at least one of the group of an inner locking operation element and outer locking operation element.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated, and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage.

1. A motor vehicle lock arrangement for a motor vehicle door, the motor vehicle lock arrangement comprising:
a motor vehicle door lock; and
a crash element;
wherein the motor vehicle door lock comprises a locking mechanism inside a housing of the motor vehicle door lock to lock the motor vehicle door lock, wherein the locking mechanism has at least one transmission element arranged on the outside of the housing, wherein the transmission element is configured to transmit an actuating movement to the locking mechanism, and wherein the transmission element is configured for connection with at least one of the group of an inner locking operation element and outer locking operation element;
wherein the crash element comprises a first abutment portion and a second abutment portion;
wherein the first abutment portion is configured to be urged by a deformed outer cover sheet of a motor vehicle door in case of a deformation of the outer cover sheet due to a crash, thus causing at least a partial movement of the crash element; and
wherein the second abutment portion is configured to urge on the transmission element in case of the at least partial movement of the crash element, thus causing a movement of the transmission element for locking of the vehicle door lock by the locking mechanism.

2. Motor vehicle lock arrangement according to claim 1, wherein a pivot support is provided and the crash element is a crash lever pivotably hold by the pivot support.

3. Motor vehicle lock arrangement according to claim 2, wherein the pivot support is provided by:
the housing of the motor vehicle door lock;
a support structure of the vehicle lock arrangement; or
a structural part of the door.

4. Motor vehicle lock arrangement according to claim 1, wherein a projection is provided on the crash element for abutment on a rigid support portion to act as secondary pivot support when the crash element is moved by the deformation of the outer cover sheet in relation to the rigid portion; and
wherein the rigid support portion and the pivot support are provided on different structural parts.

5. Motor vehicle lock arrangement according to claim 1, wherein the transmission element is provided as a transmission lever, and the second abutment portion is configured to act on the transmission lever in a crash situation to cause an activation of the transmission lever for locking the motor vehicle door lock, for example by a pivoting movement of the transmission latch.

6. Motor vehicle lock arrangement according to claim 1, wherein the crash element is hold with a holding force to prevent unintended movement; and
wherein the holding force is lower than an urging force resulting from the deformation of the outer cover in a crash situation.

7. Motor vehicle lock arrangement according to claim 1, wherein for manually unlocking the locking mechanism after a crash, the crash element can be displaced with an opening force acting on the transmission element such that the transmission element is no longer blocked in a locked state.

8. A lock module for a motor vehicle door, the lock module comprising:
a motor vehicle lock arrangement for a motor vehicle door;
a support structure;
wherein the motor vehicle lock arrangement comprises:
a motor vehicle door lock; and
a crash element;
wherein the motor vehicle door lock comprises a locking mechanism inside a housing of the motor vehicle door lock to lock the motor vehicle door lock, wherein the locking mechanism has at least one transmission element arranged on the outside of the housing, wherein the transmission element is configured to transmit an actuating movement to the locking mechanism, and wherein the transmission element is configured for connection with at least one of the group of an inner locking operation element and outer locking operation element;
wherein the crash element comprises a first abutment portion and a second abutment portion;
wherein the first abutment portion is configured to be urged by an outer cover sheet of a motor vehicle door in case of a deformation of the outer cover sheet, thus causing at least a partial movement of the crash element; and
wherein the second abutment portion is configured to urge on the transmission element in case of the at least partial movement of the crash element, thus causing a movement of the transmission element for locking of the vehicle door lock by the locking mechanism;
wherein the motor vehicle lock arrangement is mounted to the support structure;
wherein the support structure is configured to be mounted to a door frame structure of a motor vehicle door; and
wherein the support structure provides support for at least one of the group of motor vehicle lock, inner door handle, outer door handle, drive elements for the motor vehicle lock, drive elements for an electrically driven window pane, window pane guidance and sensor elements.

9. Lock module according to claim 8, wherein the support structure is provided with a pivot support to pivotably hold the crash element.

10. Lock module according to claim 8, wherein the support structure is provided as a multifunctional bracket configured as mounting structure for pre-mounting of components of the vehicle door.

11. A motor vehicle door module for a motor vehicle door arrangement, comprising:
a motor vehicle lock arrangement for a motor vehicle door; and
a mounting plate structure;
wherein the motor vehicle lock arrangement comprises:
a motor vehicle door lock; and
a crash element;
wherein the motor vehicle door lock comprises a locking mechanism inside a housing of the motor vehicle door lock to lock the motor vehicle door lock, wherein the locking mechanism has at least one transmission element arranged on the outside of the housing, wherein the transmission element is configured to transmit an actuating movement to the locking mechanism, and wherein the transmission element is configured for connection with at least one of the group of an inner locking operation element and outer locking operation element;
wherein the crash element comprises a first abutment portion and a second abutment portion;
wherein the first abutment portion is configured to be urged by an outer cover sheet of a motor vehicle door in case of a deformation of the outer cover sheet, thus causing at least a partial movement of the crash element; and
wherein the second abutment portion is configured to urge on the transmission element in case of the at least partial movement of the crash element, thus causing a movement of the transmission element for locking of the vehicle door lock by the locking mechanism;
wherein the motor vehicle lock arrangement is mounted to the mounting plate structure; and
wherein further components of the motor vehicle door are mounted to the mounting plate structure; and
wherein the mounting plate structure is configured to be mounted to a door frame structure of a motor vehicle door.

12. A method for locking a motor vehicle door in a crash situation, the method comprising the following steps:
a) deforming an outer cover sheet of a motor vehicle door in a crash situation; and
b) transforming the deformation of the outer cover sheet as an actuating movement to a locking mechanism of a motor vehicle door lock by:
b1) moving a crash element from an initial state towards a locking state by urging of the deformed outer cover onto a first abutment portion of the crash element; and
b2) moving a transmission element, which is configured to transmit an actuating movement to the locking mechanism, by urging of a second abutment portion of the crash element onto the transmission element;
wherein the locking mechanism is arranged inside a housing of the motor vehicle door lock to lock the motor vehicle door lock; and
wherein the transmission element is arranged on the outside of the housing, and the transmission element is configured to transmit an actuating movement to the locking mechanism, and wherein the transmission element is configured for connection with at least one of the group of an inner locking operation element and outer locking operation element.
